(19) United States
(12) Patent Application Publication
(10) Pub. No.: US 2012/0173843 A1
(43) Pub. Date: Jul. 5, 2012

(54) TRANSLATION LOOK-ASIDE BUFFER INCLUDING HAZARD STATE

(76) Inventor: Chetan C. Kamdar, Austin, TX (US)

(21) Appl. No.: 13/191,088

(22) Filed: Jul. 26, 2011

Related U.S. Application Data
(60) Provisional application No. 61/429,569, filed on Jan. 4, 2011.

(51) Int. Cl. G06F 12/10

(52) U.S. Cl. 711/207; 711/E12.061

(57) ABSTRACT

A system may include a storage medium with multiple entries, each entry of the configured to store a respective address of a memory write request that has not yet been committed to memory. The system may further include a translation lookaside buffer (TLB) including a multiple TLB entries, each TLB entry having an associated address field and associated one or more hazard status fields. The address field may store a translated physical memory address. Each hazard status field may correspond to a respective storage entry of the storage medium, and contain respective information indicating whether the translated physical memory address matches the respective address in the respective storage entry. The system may also include hazard detection logic to receive the respective information from the TLB, and use the respective information to prevent a hazard from occurring when the translated physical memory address is associated with a memory write request that has not yet been committed to memory.

### BACKGROUND

1. Technical Field

This disclosure relates to integrated circuits, and more particularly to translation lookaside buffers.

2. Description of the Related Art

In most computer systems, accesses to memory requested by a central processing unit are typically handled by a memory management unit, also referred to as paged memory management unit (PMMU). One of the primary memory management functions is the translation of virtual addresses to physical addresses, referred to as virtual memory management. Other memory management functions include memory protection, cache control, and bus arbitration. The virtual address space (i.e. the range of addresses used by the central processing unit) is typically divided into pages, with the bottom ‘n’ bits of the address (i.e. the offset within a page) left unchanged. The upper address bits represent the virtual page numbers. The virtual page numbers are typically translated into physical page numbers via an associative cache called the Translation Lookaside Buffer (TLB).

A TLB can include a number of entries for storing physical addresses that have been translated from virtual addresses (VA). A TLB entry may also include information about whether the page has been written to (referred to as ‘dirty bit’), when the page was last used, what kind of processes can read and write the page, and whether the page should he cached. Most processor designs that have paging mechanisms as part of the memory subsystem include a TLB to shorten the time required to do page translations and to access memory. The TLB is typically implemented as content-addressable memory, with the search key provided by the virtual address, and the search yielding a physical address as the result. If the requested address is present in the TLB, a match to a physical address is established, and the physical address can be quickly retrieved to access the memory. This is referred to as a TLB hit. If the requested address is not present in the TLB, referred to as a TLB miss, the translation process includes looking up the page table, involving reading the contents of multiple memory locations and using them to compute the physical address. After the physical address is thereby determined, the virtual address to physical address mapping is entered into the TLB.

Physical addresses retrieved from a TLB can be placed in a TLB pipeline to be accessed according to the various instructions that were requiring the memory access. The timing of subsequent accesses to a same address may sometimes present a problem. For example, a hazard condition can develop when a physical address retrieved from the TLB corresponds to a previous write instruction that has already been placed in the TLB pipeline, but has not yet been committed to memory. Such hazards need to be detected and handled appropriately, yet this type of hazard detection may be unacceptably slow in many systems.

### SUMMARY OF THE INVENTION

In one set of embodiments, a system may include a storage medium having storage entries, each storage entry storing a respective address of a respective memory write request that has not yet been committed to memory. The system may also include a translation lookaside buffer (TLB) having TLB entries, each TLB entry including an address field and one or more hazard status fields. The address field may store a translated physical memory address, while each hazard status field of the TLB entry may correspond to a respective storage entry of the storage medium, and contain respective information indicating whether the translated physical memory address matches the respective address in the respective storage entry. The system may further include comparator logic to compare the respective address in each respective storage entry with a translated physical memory address being written into the TLB in response to a TLB write operation, and provide respective information indicating whether the translated physical memory address matches the respective address in the respective storage entry.

The TLB may store the respective information into a corresponding hazard status field of the TLB entry, to indicate hazard status associated with the translated physical address stored in the address field of the same TLB entry. In some embodiments, hazard detection logic may be included to receive the respective information, and use the respective information to prevent a hazard from occurring when the translated physical memory address is associated with a memory write request that has not yet been committed to memory.

In one set of embodiments, addresses associated with respective memory write requests that have not yet been committed to memory may be stored in respective entries of a queue. Translated physical memory addresses may also be stored within respective address fields of respective entries of a translation lookaside buffer (TLB). In addition, respective hazard status indications may be stored within respective hazard status fields of the respective entries of the TLB, with each respective hazard status field of the respective entry of the TLB associated with a respective entry of the queue. The TLB may be accessed as part of a response to a bus operation request. As part of the TLB access, a TLB entry may be identified according to the bus operation request, for example based on a virtual address associated with the bus operation request, which may be a read (load) or write (store) request.

The respective hazard status indications stored within the respective hazard status fields of the identified TLB entry may be used to determine whether the translated physical memory address stored within the respective address field of the identified TLB entry is associated with a memory write request that has not yet been committed to memory. In response to determining that the translated physical memory address stored within the respective address field of the identified TLB entry is not associated with a memory write request that has not yet been committed to memory, the translated physical memory address may be retrieved from the respective address field of the identified TLB entry, and stored in one of the respective entries of the queue. In some embodiments the queue may be a first-in-first-out buffer, and the translated physical memory address may be stored to the back entry of the FIFO buffer.

Alternatively, in response to determining that the translated physical memory address stored within the respective address field of the identified TLB entry is associated with a memory write request that has not yet been committed to memory, the respective hazard status indications stored within the respective hazard status fields of the identified TLB entry may be provided to hazard detection logic, which may use the respective hazard status indications to prevent a hazard condition from occurring when using the translated physical memory address stored within the respective address field of the identified TLB. Any one of the respective entries of the queue may be updated with a retrieved translated physical address from the TLB, where the retrieved translated physical address is associated with a new bus operation request.

### BRIEF DESCRIPTION OF THE DRAWINGS

FIG. 1 is a block diagram of one embodiment of an integrated circuit that includes a processor core with a Translation Lookaside Buffer (TLB).

FIG. 2 is a block diagram of one embodiment of a TLB and associated hazard detection logic.

FIG. 3 is a block diagram of another embodiment of the translation TLB and associated hazard detection logic of FIG. 1.

FIG. 4 is a flow diagram depicting operational aspects of the TLB and associated hazard detection logic of FIG. 3.

FIG. 5 is a block diagram of one embodiment of a system that uses one or more TLBs.

Specific embodiments are shown by way of example in the drawings and will herein be described in detail. It should be understood, however, that the drawings and detailed description are not intended to limit the claims to the particular embodiments disclosed, even where only a single embodiment is described with respect to a particular feature. On the contrary, the intention is to cover all modifications, equivalents and alternatives that would be apparent to a person skilled in the an having the benefit of this disclosure. Examples of features provided in the disclosure are intended to be illustrative rather than restrictive unless stated otherwise.

As used throughout this application, the word “may” is used in a permissive sense (i.e., meaning having the potential to), rather than the mandatory sense (i.e., meaning must). Similarly, the words “include,” “including,” and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph six, interpretation tor that unit/circuit/component.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

### DETAILED DESCRIPTION

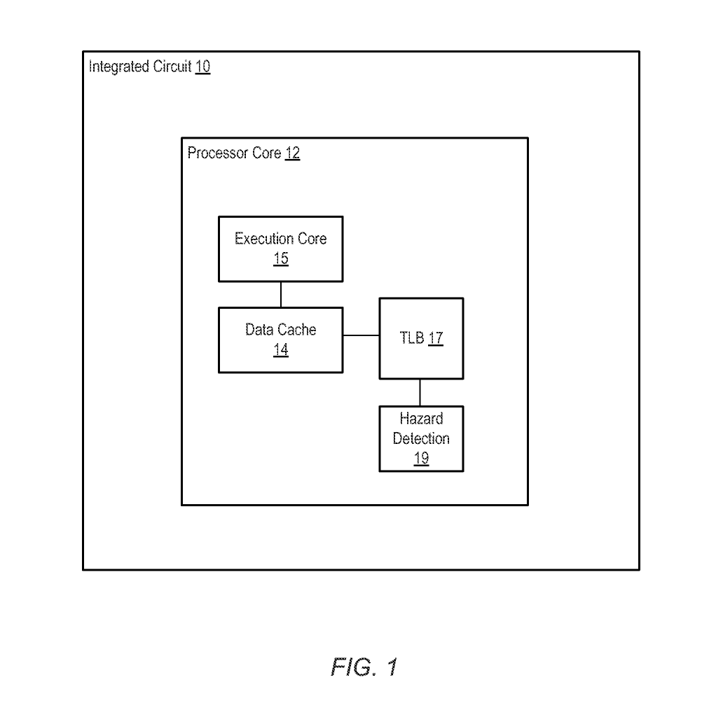

FIG. 1 shows the block diagram of one embodiment of an integrated circuit (IC) that includes a processor core with a Translation Lookaside Buffer (TLB). The integrated circuit 10 may include a processor core 12, which may itself include an execution core 15 coupled to a data cache 14, which is in turn may be coupled to a TLB 17. The TLB 17 may be coupled to hazard detection logic 19. It should be noted, that even though only a single processor core 12 is shown in FIG. 1, other embodiments may feature any number of additional processor cores, and the configuration of each additional processor core may be the same, similar, or different from the configuration of processor core 12. It should further be noted, that execution core 15, data cache 14, and TLB 17 do not need to be coupled to each other as shown in FIG. 1. For example, in some embodiments cache 14 may be physically indexed, and execution core 15 may access TLB 17 to get a physical address, which may be used to access cache 14. If the index is virtual, and the tag is physical, then execution core 15 may access data cache 14 and TLB 17, and the output of TLB 17 may be provided to the tag store. If the index and tag are both virtual, then execution core 15 may access data cache 14, the tag store, and TLB 17, and the output of TLB 17 and tag store may be sent to anti-aliasing logic. Therefore, in some embodiments, execution core 15 may be coupled to both data cache 14 and TLB 17, as opposed to data cache 14 being coupled in-between execution core 15 and TLB 17. Other arrangements of these components are also possible and are contemplated.

In some embodiments, processor core 12 may implement an address translation scheme in which one or more virtual address (VA) spaces are made visible to software (programming instructions) that may be executed by processor core 12. Memory accesses within the virtual address space may be translated to a physical address (PA) space corresponding to the actual physical memory available to the system. Memory translation may be performed according to one or more different translation methods, for example by using a set of page tables, segments, or other virtual memory translation schemes. In embodiments that employ address translation, a cache such as data cache 14 may be partially or completely addressed using physical address bits rather than virtual address bits. For example, data cache 14 may use virtual address bits for cache indexing and physical address bits for cache tags.

To avoid the cost of performing a full memory translation when performing a cache access, processor core 12 may store a set of recent and/or frequently-used virtual-to-physical address translations in a translation lookaside buffer (TLB), such as TLB 17. During operation of integrated circuit 10, and consequently, during operation of processor core 12, TLB 17—which may be implemented as a cache memory, as a content addressable memory (CAM), or using any other suitable circuit structure—may receive virtual address information and determine whether a valid translation is already available. If the virtual address information successfully identifies an entry in TLB 17, indicating that a physical address corresponding to the virtual memory address is present, TLB 17 may simply provide the corresponding physical address bits to the data cache 14. If a physical address corresponding to the virtual memory address is not present, TLB 17 may effect a translation operation to determine the physical address that corresponds to the virtual address, for example by raising a virtual memory exception, which may result in a page table walk to obtain the corresponding physical memory address.

In various embodiments, TLB 17 may include a data array with a number of entries for storing the translated physical addresses. In one set of embodiments, physical addresses retrieved from TLB 17 may be provided to a pipelined operation. For example, the retrieved physical addresses may be stored in a queue, such as a first-in-first-out (FIFO) buffer having a specified number of entries, each entry representative of a stage of a pipeline. The physical addresses may move down the pipeline, and any respective physical address may be cleared from the FIFO once the operation associated with the respective physical address has occurred, for example when a write operation has been committed to memory. In one embodiment, the physical address provided by TLB 17 once a given TLB entry has been read may be compared to the addresses presently in the FIFO. For example, it may be compared to physical addresses in the FIFO that correspond to memory write requests that have not yet been serviced (i.e., written to memory) and which may present hazards. This hazard information may be provided to additional hazard detection logic 19 for further processing.

Furthermore, in another set of embodiments, each entry in TLB 17 may additionally store hazard status information associated with the FIFO locations and/or, for example, with addresses that correspond to the memory write requests that have not yet been serviced (i.e., written to memory) and which may present hazards. Accordingly, as will be further described below, hazard detection logic 19 may include comparator logic that may compare each TLB write address with addresses of the outstanding memory writes to generate the hazard information. In some embodiments, hazard information may be stored as hazard status indicators or hazard status information in each entry of the TLB 17. In addition, the hazard status information in any given respective entry of TLB 17 may be updated upon a TLB hit that was caused by a store operation. Accordingly, the hazard status information stored within each entry of TLB 17 may be provided to the hazard detection logic 19 for further processing when a given TLB entry is read, which may make the hazard status information available to hazard detection logic 19 within a shorter time period than what may be required when the hazard information has to be generated using the comparator logic.

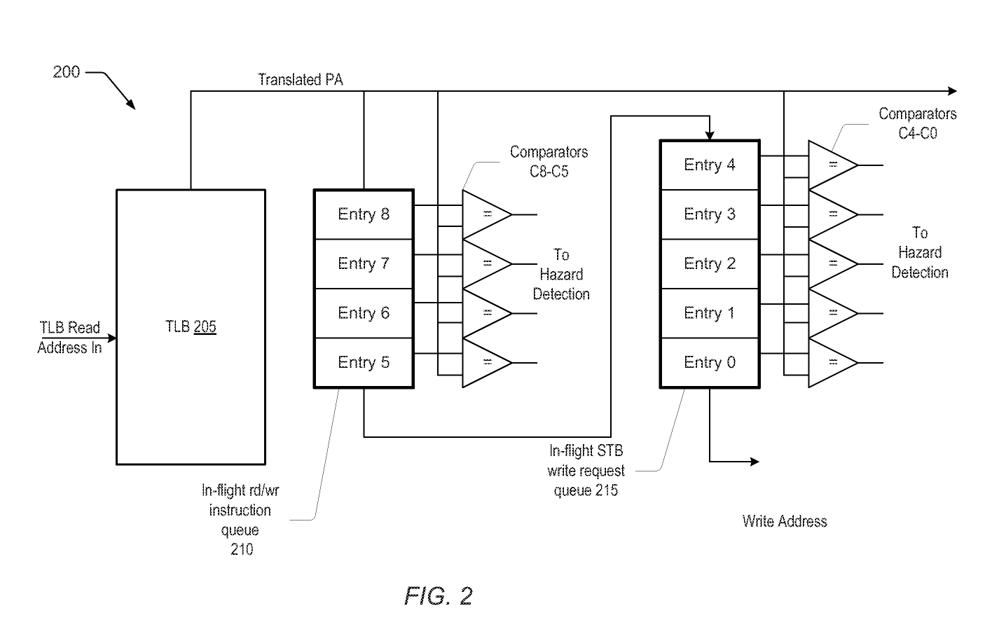

FIG. 2 shows a block diagram of one embodiment of a TLB, such as TLB 17 of FIG. 1, including logic associated with the TLB. Circuit 200 includes a TLB 205 which is coupled to a FIFO structure to store various information associated with or obtained from TLB 205. In one set of embodiments, the FIFO may include an in-flight instruction queue 210 which may include a specified number of entries, e.g. four entries, and which may be coupled to an in-flight store buffer (STB) write request queue 215 that may also include a specified number of entries, e.g. five entries. It should be noted that the nature of the information stored in the FIFO, and the designation and number of the FIFO entries may be different in alternate embodiments, and the entries shown in FIG. 2 are for illustrative purposes to highlight overall operation of circuit 200. The TLB 205 may receive a TLB read address In (e.g., a VA). In addition, the translated PA address output of the TLB 205 may be coupled to a number of comparators (e.g., C0-C8). As shown in FIG. 2, each entry of the queues 210 and 215 may also be coupled to a respective comparator of comparators C0-C8).

In one set of embodiments, as VA addresses are received by TLB 205 for a TLB lookup, and result in a hit in TLB 205, the PA address that is output by TLB 205 is compared to each entry within queues 210 and 215. The comparator results may then be used by hazard detection logic 19 of FIG. 1 to determine whether read/write dependencies (hazards) exist, and if so what, if any action needs to be taken. However, this implementation may cause unacceptable/unnecessary delays in waiting for the comparisons to be performed after the translated PA address is output by the TLB 205.

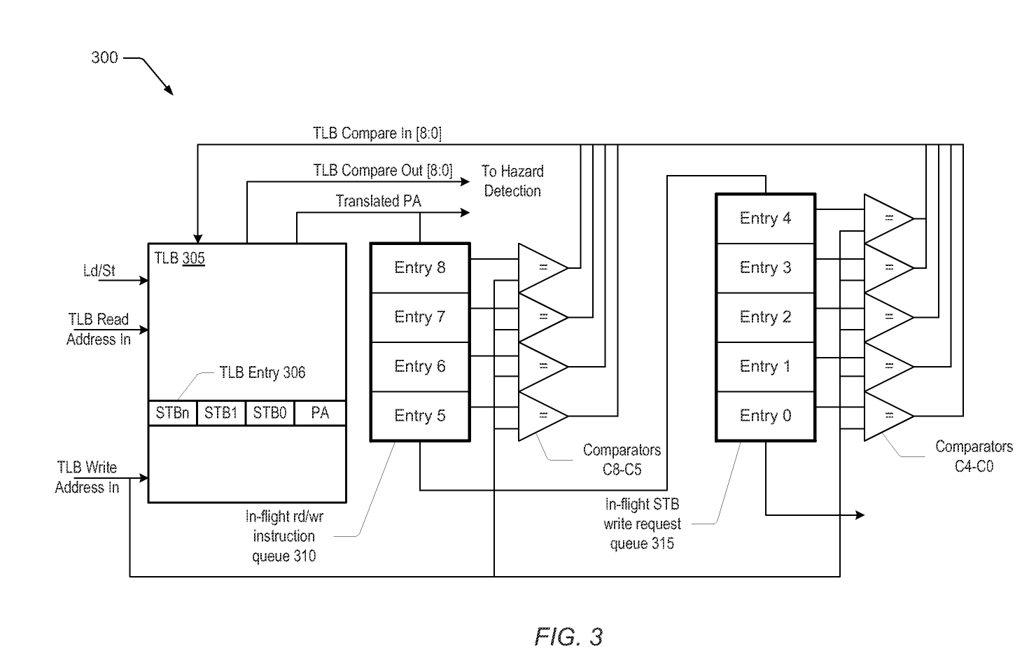

In another set of embodiments, as previously mentioned, the hazard comparisons may be performed upon a write into the TLB, and the results may be stored in the TLB along with the translated PA. FIG. 3 shows one embodiment of a TLB structure in which the hazard comparisons are performed when writing into the TLB, and the hazard status information is stored in the TLB along with the translated PAs. This approach may render the comparison(s) performed by comparators C0-C8 less critical, since the hazard status information may already be available when the TLB is read during, for example, a TLB lookup.

FIG. 3, then, shows a block diagram of another embodiment of the TLB 17 of FIG. 1, with associated logic. Circuit 300 includes a TLB 305 which is coupled to provide a translated PA address to a FIFO, which may include an in-flight instruction queue 310 which may include a specified number of entries, e.g. four entries, and which may be coupled to an in-flight store buffer (STB) write request queue 315 that may also include a specified number of entries, e.g. five entries. As was the case for the system shown in FIG. 2, it should also be noted here that the nature of the information stored in the FIFO, and the designation and number of the FIFO entries may be different in alternate embodiments, and the entries shown in FIG. 3 are for illustrative purposes to highlight overall operation of circuit 300. The TLB 305 may also provide output information (e.g., TLB Compare Out [8:0]) to additional hazard detection logic such as hazard detection logic 19 of FIG. 1, for example. TLB 305 may receive compare in information (e.g., TLB Compare In [8:0]), a TLB write address, a TLB read address, and an indication of whether a TLB lookup is caused by a load or a store operation. In addition, the TLB write address may be provided to a number of comparators (e.g., C0-C8). As shown, each entry of the queues 310 and 315 may also be coupled to a respective one of the comparators.

As described above, the TLB 305 may include a number of entries, each corresponding to one or more VAs. As shown, an exemplary entry 306 includes an address field for storing a PA translation for the entry, as well as a number of hazard status information fields. The hazard status information fields are shown as STB1, STB2, STBn, where n may be any number. Each of the STB hazard status information fields in the entry may correspond to a particular entry in the FIFO, which is represented by queues 310 and 315 in circuit 300. As previously mentioned, more generally the FIFO may be a pipeline queue with entries for PAs and/or other information associated with the PAs, such as instructions. For example, STBn may correspond to entry eight of the queue 310, and STB0 may correspond to entry zero of the queue 315. In some embodiments, the comparator results (e.g., TLB Compare In [8:0]) may be stored in the hazard status information fields of each TLB entry 306. In other embodiments, comparison may be performed by other similar means at the time a TLB entry is generated and/or updated. In any case, the hazard status information corresponds to a respective PA, as illustrated by way of TLB entry 306.

In one embodiment, the comparison result may be an indication of whether or not a hazard may exist between the TLB write address and addresses stored in the queues 310 and 315, which may be addresses of outstanding memory write requests. In other words, the indication in a given TLB entry may indicate that there is an outstanding store instruction with the same PA that has not been committed to memory. One example of such a hazard is a Read-after-Write hazard, in which case a read is attempted from a specified memory location that still has an outstanding write operation associated with it. That is, a read operation may be attempted at a PA location in memory while there is still a pending, previously issued write operation targeting that same PA location. For example, a first program (which may be executing on processor core 12, for example) may first attempt to write to a first virtual address corresponding to a specific PA. The same first program may then attempt to read information from the same first virtual address corresponding to the specific PA, or from a second virtual address corresponding to the same specific PA. However, the read request may reach the TLB 305 before the previously received write request has been cleared from queues 310 and 315, that is, before the write to the specific PA has actually taken place. This hazard needs to be detected, thus, in one set of embodiments, hazard information associated with the specific PA may be generated and communicated to a hazard detection block (e.g. hazard detection block 19), in order to delay the read operation from the specific PA until the write operation that is supposed to take place to the specific PA before the read operation is completed. It should also be noted that it is conceivable that the aforementioned hazard may occur when a second program attempts to read information from same specific PA before the previously received write request has been cleared from queues 310 and 315. However, in most architectures, the TLB and caches are flushed before execution of a second program, and in such cases the hazard would not occur when the second program tried to read information from the same specific PA.

As previously mentioned, queues 310 and 315 may be implemented as a first-in first-out (FIFO) buffer in which new information is stored into entry eight and information is read from entry zero. In addition, the information stored in each entry may he shifted to the next entry each time the information in entry zero is read out. In another embodiment, rather than the information shifting from entry to entry, read and write pointers may be used to effectively keep track of the head and tail, and individual entries may also be accessed independently of each other. Further, in one embodiment, some number of entries may store addresses corresponding to both load (read) and store (write) operations while other entries may only store addresses corresponding to store operations. For example, in the embodiment shown in FIG. 3, entries eight through five may store addresses corresponding to both load (read) and store (write) operations while entries four through zero may only store addresses corresponding to store operations. As such, only addresses corresponding to store operations may propagate to entry four of queue 315. In one embodiment, if the queues 310 and 315 become full, then requests may stall and/or be retried. It should be noted again that although there are nine entries shown collectively in the queues 310 and 315, in other embodiments and number of queue entries may be used.

The translated PA that is returned for a read miss or write miss may be stored in entry eight of the queue 310 after a TLB lookup is performed. In one embodiment, a given entry of the queues 310 and 315 may be invalidated such as when a given read operation commits. In such a case, the FIFO pointers may collapse/or the information may be shifted to fill the vacant entry as desired. In other embodiments the structure of the queues 310 and 315 may be such that each entry may be independently read and written at random using pointers that track the age of each entry so that the oldest entry is always output. It should also be noted that alternate embodiments may not include the comparators C8-C0, and initial determination of PAs corresponding to outstanding write (and/or read) operations may be determined by through other means, or by different circuitry that may be incorporated into TLB 305 itself, or by referencing indexing information associated with the FIFO (queues 310 and 315 in the example shown). In any case, the TLB entries 306 may obtain and store information indicating whether a potential for a hazard associated with a current instruction targeting a specific PA address exists. Since information corresponding to the outstanding operations is stored in the FIFO, hazard information associated with each location of the FIFO may be stored in TLB 305 for each PA stored in TLB 305. This hazard information may then be retrieved from TLB 305 and used to properly handle the potential hazard condition to ensure that the actual hazard is prevented, in a fast and efficient manner.

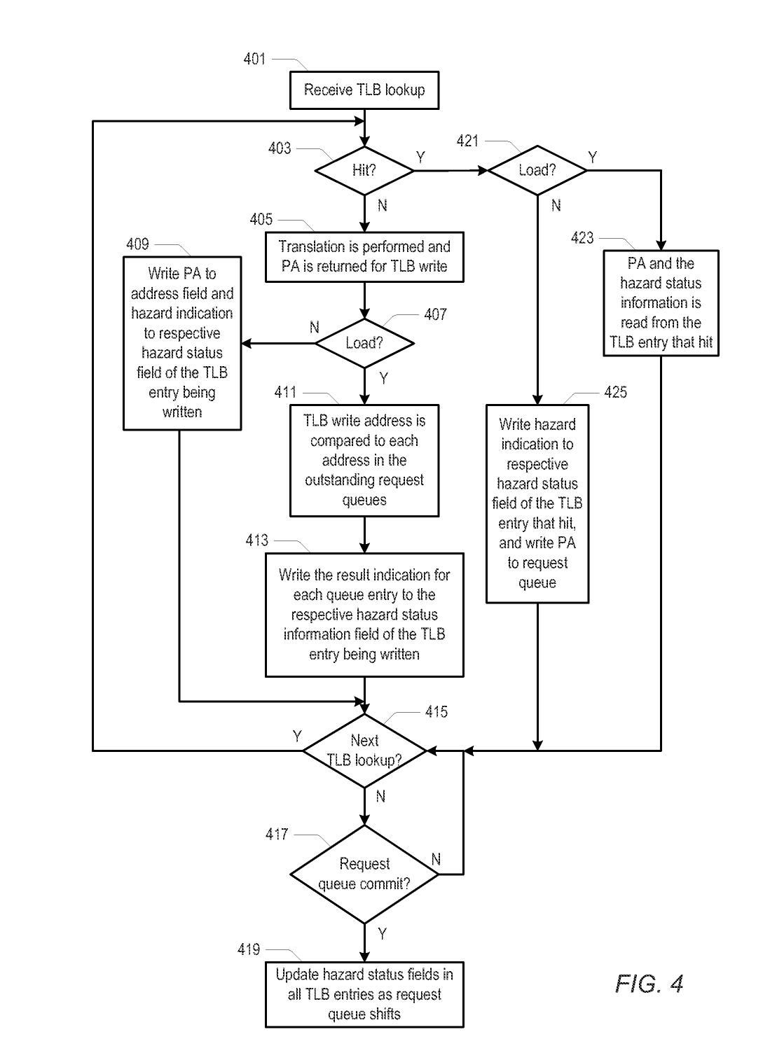

FIG. 4 shows a flow diagram describing operational aspects of the embodiment of the TLB and associated hazard detection logic of FIG. 3. Referring collectively to FIG. 3 and FIG. 4, and starting in block 401 of FIG. 4, a TLB lookup request is received. If the TLB lookup does not return a hit (block 403—‘N’ branch), the system (e.g., operating system or memory management hardware) performs an address translation as previously described above. Once the address translation is complete, the system may perform a TLB write to a given entry of the TLB 17 by providing the translated PA to the TLB 17 (block 405). If the TLB lookup is not result of a load operation, e.g. it is a store operation, (block 407—‘N’ branch), the translated PA is written to the corresponding address field of the TLB entry, i.e. the entry location within the TLB defined by the virtual address that was received (block 409). In addition, the hazard status field corresponding to entry eight of the queue 310 is asserted or caused to indicate that an uncommitted store operation is in the store buffer (block 409). Operation proceeds to block 415 to wait for the next TLB lookup.

Referring back to block 407, if the TLB lookup is the result of a load operation (‘Y’ branch of 407), the TLB write address is compared to each entry in the outstanding request queues 310 and 315 (block 411). The result of each comparison may then be written into a corresponding hazard status field of the given entry of the TLB 17 that is being written with the new translated PA (block 413). That is, the result of each comparison may correspond to a respective entry in queues 310 and 315, written into a corresponding respective hazard status field associated with the corresponding address field of the TLB entry, i.e. the entry location within the TLB defined by the virtual address that was received. In one set of embodiments, the result of each comparison may also be provided to hazard detection block to ‘record’ the hazard condition, in case there is a match with one of the entries queues 310 and 315. The operation may then proceed to block 415 to wait for the next TLB lookup.

Referring back to block 403, if a TLB lookup result in a hit (‘Y’ branch), and the TLB lookup is not the result of a load operation (block 421—‘N’ branch), the hazard status field (in the TLB) corresponding to the beginning entry in the FIFO, i.e. corresponding to entry eight of queue 310 may be asserted to indicate that an uncommitted store operation is in the store buffer, and the translated PA may be written from the TLB to the entry eight of the queue 310 (block 425). In general, hazard indication may be written to the respective hazard status field of the TLB entry that resulted in the hit, and the PA may be written to the request queue (block 425). The operation may then proceed to block 415 to wait for the next TLB lookup.

Referring back to block 421, if the TLB lookup is the result of a load operation (‘Y’ branch), the translated PA and the hazard status information may be read from the TLB entry that resulted in the hit, and may be provided to additional hazard detection logic 19 for further processing (block 423). For example, if a load operation results in a hit in the TLB and that PA also has a pending uncommitted memory write associated with it, for example the same PA being stored in one or more of the entries in queues 310 and 315, then a hazard has been detected and may be appropriately handled.

While awaiting the next TLB lookup (block 415), for example, if an outstanding read request or write request is committed (block 417), that is, once the read operation or write operation to the PA takes place, the queues 310 and 315 shift and/or collapse as described above. In addition, the hazard status information in each TLB entry may also shift from one field to the next to maintain the correspondence between queue entries and hazard status information fields. If there are no requests committed, operation proceeds as described above in block 415. It should be noted that while block 417 (“Request queue commit”) is shown to proceed from block 415 (“Next TLB lookup”), the request queue commit is not dependent on the next TLB lookup, and the two operation may be performed in parallel.

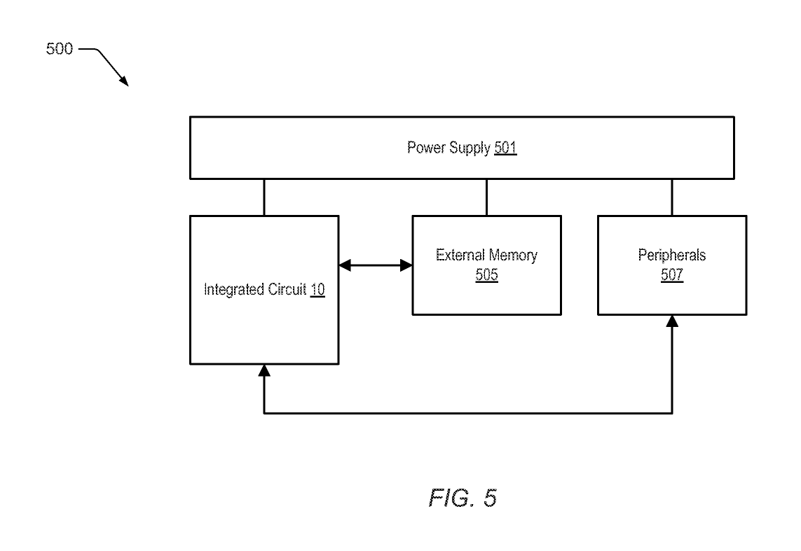

FIG. 5 shows a block diagram of one embodiment of a system that may include a TLB and associated circuitry operating as described above. The system 500 may include at least one instance of an integrated circuit 10 coupled to one or more peripherals 507 and an external system memory 505. The system 500 may also include a power supply 501 that may provide one or more supply voltages to the integrated circuit 10 as well as one or more supply voltages to the memory 505 and/or the peripherals 507.

In the illustrated embodiment, the system 500 includes at least one instance of an integrated circuit 10. The integrated circuit 500 may include one or more instances of the processor core 12 (from FIG. 1). The integrated circuit 500 may, in one embodiment, be a system on a chip including one or more instances of the processor core 12 and various other circuitry such as a memory controller, video and/or audio processing circuitry, on-chip peripherals and/or peripheral interfaces to couple to off-chip peripherals, etc.

The peripherals 507 may include any desired circuitry, depending on the type of system. For example, in one embodiment, the system 500 may be included in a mobile device (e.g., personal digital assistant (PDA), smart phone, etc.) and the peripherals 507 may include devices for various types of wireless communication, such as WiFi, Bluetooth, cellular, global positioning system, etc. The peripherals 507 may also include additional storage, including RAM storage, solid-state storage, or disk storage. The peripherals 507 may include user interface devices such as a display screen, including touch display screens or muititouch display screens, keyboard or other input devices, microphones, speakers, etc. In other embodiments, the system 500 may be included in any type of computing system (e.g. desktop personal computer, laptop, workstation, net top etc.).

The external system memory 505 may include any type of memory. For example, the external memory 505 may be in the DRAM family such as synchronous DRAM (SDRAM), double data rate (DDR, DDR2, DDR3, etc.), or any low power version thereof. However, external memory 505 may also be implemented in SDRAM, static RAM (SRAM), or other types of RAM, etc.

Although the embodiments above have been described in considerable detail, numerous variations and modifications will become apparent to those skilled in the art once the above disclosure is fully appreciated. It is intended that the following claims be interpreted to embrace all such variations and modifications.

We claim:

1. A system comprising:
a storage including a plurality of storage entries, wherein each storage entry of the plurality of storage entries is configured to store a respective address of a memory write request that has not yet been committed to memory;
a translation lookaside buffer (TLB) including a plurality of TLB entries, wherein each TLB entry of the plurality of TLB entries includes a plurality of associated fields including:
an address field configured to store a translated physical memory address; and
one or more hazard status fields, each hazard status field of the one or more hazard status fields corresponding to a respective storage entry of the plurality of storage entries, and containing respective information indicating whether the translated physical memory address matches the respective address in the respective storage entry.

2. The system of claim 1, further comprising:
comparator logic configured to compare the respective address in each respective storage entry with a translated physical memory address being written into the TLB in response to a TLB write operation, and provide respective information indicating whether the translated physical memory address matches the respective address in the respective storage entry;
wherein the TLB is further configured to store the respective information into a corresponding hazard status field of the one or more hazard status fields.

3. The system of claim 1, further comprising:
hazard detection logic configured to receive the respective information, and use the respective information to prevent a hazard from occurring when the translated physical memory address is associated with a memory write request that has not yet been committed to memory.

4. The system of claim 1, further comprising an execution core configured to execute programming instructions that result in an access to the TLB.

5. The system of claim 4, further comprising a data cache coupled to the execution core.

6. A method comprising:
storing a respective address of a memory write request which has not been committed to memory in a respective entry of a storage, wherein the storage includes a plurality of entries;
accessing a translation lookaside buffer (TLB) in response to a present write operation;
obtaining a first translated physical memory address associated with the present write operation;
comparing the first translated physical memory address with the respective address stored within each respective entry of the storage;
generating a respective hazard status indication corresponding to each respective entry in the storage, indicating whether the first translated physical memory address matches the respective address in the respective entry of the storage;
storing the first translated physical memory address within a respective address field of a first entry of the TLB;
storing each respective hazard status indication into a respective hazard status field of the first entry of the TLB, wherein each respective hazard status field of the first entry of the TLB is associated with a respective entry of the storage.

7. The method of claim 6, further comprising:
providing each respective hazard status indication to hazard detection logic to process the respective hazard status indication to prevent a hazard from occurring when the first translated physical memory address is associated with a memory write request that has not yet been committed to memory.

8. The method of claim 6, further comprising:
accessing the TLB in response to a present read operation;
retrieving from the respective address field of a second entry of the TLB a second translated physical memory address corresponding to the present read operation;
retrieving each respective hazard status indication from the respective status field of the second entry of the TLB; and
determining whether a hazard would occur because of the second translated physical memory address being associated with a memory write request that has not yet been committed to memory.

9. The method of claim 7, wherein determining whether a hazard would occur comprises:
providing each respective hazard status indication from the respective status field of the second entry of the TLB to a hazard detection logic; and
the hazard detection logic determining whether the hazard would occur.

10. The method of claim 8, further comprising delaying the present read operation until the memory write request associated with the second translated physical memory address has been committed to memory.

11. A method comprising:
storing, in respective entries of a storage, addresses associated with respective memory write requests that have not yet been committed to memory;
storing translated physical memory addresses within respective address fields of respective entries of a translation lookaside buffer (TLB);
storing respective hazard status indications within respective hazard status fields of the respective entries of the TLB, wherein each respective hazard status field of the respective entry of the TLB is associated with a respective entry of the storage; and
accessing the TLB in response to a bus operation request, comprising:
identifying a TLB entry according to the bus operation request; and
determining from the respective hazard status indications stored within the respective hazard status fields of the identified TLB entry whether the translated physical memory address stored within the respective address field of the identified TLB entry is associated with a memory write request that has not yet been committed to memory.

12. The method of claim 11, further comprising:
in response to determining that the translated physical memory address stored within the respective address field of the identified TLB entry is not associated with a memory write request that has not yet been committed to memory:
retrieving from the respective address field of the identified TLB entry the translated physical memory address; and
storing the translated physical memory address in one of the respective entries of the storage.

13. The method of claim 11, further comprising:
in response to determining that the translated physical memory address stored within the respective address field of the identified TLB entry is associated with a memory write request that has not yet been committed to memory:
providing the respective hazard status indications stored within the respective hazard status fields of the identified TLB entry to hazard detection logic.

14. The method of claim 13, further comprising the hazard detection logic using the respective hazard status indications to prevent a hazard condition from occurring when using the translated physical memory address stored within the respective address field of the identified TLB.

15. The method of claim 11, further comprising updating one of the respective entries of the storage with a retrieved translated physical address from the TLB, wherein the retrieved translated physical address is associated with a new bus operation request.

16. A system comprising:
a queue including a plurality of queue entries, wherein each entry of the plurality of queue entries is configured to store a respective physical memory address associated with a respective pending bus operation request;
a translation lookaside buffer (TLB) including a plurality of TLB entries, wherein each TLB entry of the plurality of TLB entries includes a plurality of associated fields including:
an address field configured to store a translated physical memory address; and
one or more hazard status fields, each hazard status field of the one or more hazard status fields corresponding to a respective storage entry of the plurality of storage entries, and containing respective information indicating whether the translated physical memory address matches the respective address in the respective storage entry; and
hazard detection logic coupled to the TLB, and configured to receive the respective information, and determine from the received respective information whether a hazard condition exists for the translated physical memory address.

17. The system of claim 16, wherein the hazard detection logic is configured to prevent a hazard to develop from the hazard condition upon determining that the hazard condition exists for the translated physical memory address.

18. The system of claim 16, wherein the queue is a first-in-first-out (FIFO) buffer, wherein the plurality of queue entries comprise a front entry and a back entry, wherein the system is configured to update the FIFO buffer upon servicing the respective pending bus operation request having an associated physical memory address stored in the front entry of the FIFO, wherein in updating the FIFO buffer, the system is configured to store a translated physical memory address associated with a next pending bus operation request from the TLB into the back entry of the FIFO buffer.

19. The system of claim 16, further comprising:
comparator logic configured to compare the respective address in each respective queue entry with a translated physical memory address associated with an incoming bus operation request, and provide respective information indicating whether the translated physical memory address matches the respective address in the respective queue entry;
wherein the TLB is further configured to store the translated physical memory address associated with the incoming bus operation request in the address field of a selected TLB entry; and
wherein the TLB is further configured to store each respective information indicating whether the translated physical memory address associated with the incoming bus operation request matches the respective address in the respective queue entry, into a corresponding hazard status field of the selected TLB entry.

20. A system comprising:
a buffer having plurality of entries, each buffer entry configured to store a respective address of a corresponding memory write request which has not been committed to memory;
a translation lookaside buffer (TLB) having a plurality of TLB entries, each TLB entry comprising:
an address field configured to store a translated physical memory address; and
one or more status fields, each status field corresponding to a respective buffer entry of the buffer; and
comparator logic coupled to the TLB and configured to compare the respective address stored in each buffer entry with a translated physical memory address being written into a selected TLB entry in response to a TLB write operation, and further configured to provide respective information associated with each respective buffer entry to indicate whether the translated physical memory address being written into the selected TLB entry matches the respective address stored in the respective buffer entry;
wherein the TLB is further configured to store each respective information into the corresponding hazard status field of the one or more status fields of the selected TLB entry.

21. The system of claim 20, further comprising:
hazard detection logic coupled to the TLB, and configured to:
receive information stored in the one or more status fields of a TLB entry associated with a present bus operation request;
determine from the received information whether a hazard condition exists for the translated physical memory address stored in the address field of the TLB entry associated with the present bus operation request.

22. The system of claim 20, further comprising an external memory, wherein the translated physical memory address addresses the external memory.
